(19) United States
(12) Patent Application Publication
(10) Pub. No.: US 2016/0378917 A1
(43) Pub. Date: Dec. 29, 2016

(54) Imaging Study Queries Across Multiple Facilities And Repositories

(71) Applicant: Nuance Communications, Inc., Burlington, MA (US)

(72) Inventors: Arman Sharafshahi, Atlanta, GA (US); Willie Tillery, Atlanta, GA (US)

(21) Appl. No.: 14/748,429

(22) Filed: Jun. 24, 2015

(51) Int. Cl. G06F 19/00; G06F 17/30

(52) U.S. Cl. CPC G06F 19/321; G06F 17/30321; G06F 17/30265

(57) ABSTRACT

Methods described herein provide functionality for querying medical imaging studies across multiple facilities and repositories. One such embodiment creates an index of existing imaging study data stored at multiple repositories where the index is based on metadata regarding the existing imaging study data. Further, such an embodiment determines the existence of imaging study data relevant to an imaging study query using the created index.

### BACKGROUND OF THE INVENTION

Medical imaging studies, such as ultrasounds and magnetic resonance imaging (MRI), are invaluable to modern medicine. However, imaging studies are expensive to perform and regularly need to be performed several times, potentially at various disparate imaging facilities, in the course of medical diagnosis and treatment. Further, many medical diagnoses require making a comparison between a current imaging study and a previous imaging study. Thus, current medical practices require easy and efficient access to imaging studies, regardless of where the imaging studies were performed.

### SUMMARY OF THE INVENTION

While efficient and easy access to imaging studies is needed, current conditions make such accessibility difficult. Patients regularly have medical imaging performed at various locations and at various times. Methods are needed to (1) make such data available to the patient's various medical providers and (2) track and identify the existence of the various imaging studies that have been performed. Embodiments of the present invention fulfill these needs and provide methods and apparatuses that allow users to access imaging studies across multiple facilities and repositories.

One such embodiment creates an index of existing imaging study data stored at multiple repositories, where the index is based on metadata regarding the existing imaging study data. Such a method further includes determining an existence of imaging study data relevant to an imaging study query using the created index. According to an embodiment of the present invention, the metadata may be received from one or more accelerator devices that are located at the multiple repositories. This metadata may be received on a periodic basis, in response to a demand, or other criterion, such as an automatic determination of recent activity. According to embodiments of the present invention, the demand for metadata may be tailored. For example, a request for metadata may seek data from a particular geographic region, demographic, specific time period, or combination thereof.

An embodiment of the present invention may further include centrally queueing a plurality of imaging study queries. Further still, yet another embodiment includes providing imaging study data in response to the query if determined that relevant data exists, or otherwise providing an indication that imaging study data relevant to the query does not exist. Imaging study data, including metadata, may be received from any location that has such data, for example, an imaging facility, hospital, or physician's office. According to an embodiment, the multiple repositories are each a digital imaging and communications in medicine (DICOM) archive. Examples of DICOM archives include a picture archive and communications system (PACS) and a vendor neutral archive (VNA).

An embodiment of the present invention includes functionality to track a patient using the created index. Further still, yet another embodiment has functionality to notify a medical provider of existing imaging study data using the created index in response to an imaging study order. Such an embodiment may prevent duplicate imaging studies from being performed.

An alternative embodiment of the present invention is directed to a computer system for querying imaging studies across multiple facilities and repositories in accordance with the method embodiments described above.

Yet another embodiment of the present invention is directed to a computer program product for querying imaging studies across multiple facilities and repositories in accordance with the method embodiments described above. In such an embodiment, the computer program product comprises one or more computer-readable tangible storage devices and program instructions stored on at least one of the one or more storage devices. The program instructions, when loaded and executed by a processor, cause an apparatus associated with the processor to (1) create an index of existing imaging study data stored at multiple repositories where the index is based on metadata regarding the existing imaging study data and (2) determine an existence of imaging study data relevant to an imaging study query using the created index.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a visual depiction of a system for querying imaging studies across multiple facilities and repositories according to principles of an embodiment of the present invention.

FIG. 2 is a simplified block diagram of a cross site query engine that may be utilized to implement embodiments of the present invention.

FIG. 3 is a simplified block diagram of an imaging facility that may be employed in one or more embodiments.

FIG. 4 is a flowchart depicting a method of querying imaging studies across multiple facilities and repositories according to an embodiment of the present invention.

FIG. 5 is a simplified block diagram of a system for querying imaging studies across multiple facilities and repositories according to an example embodiment.

FIG. 6 is a simplified diagram of a computer network environment in which an embodiment of the present invention may be implemented.

### DETAILED DESCRIPTION OF THE INVENTION

A description of example embodiments of the invention follows.

As described hereinabove, quick, easy, and efficient methods for accessing existing imaging study data are needed. Further, while current technologies such as picture archiving and communications systems (PACS) and vendor neutral archives (VNA) provide some level of medical imaging study sharing, these solutions are inadequate. Firstly, the current technologies do not offer query federation. Secondly, existing solutions rely heavily on virtual private networks (VPNs), expensive infrastructure, and lengthy legal negotiations to provide access to imaging study data. Embodiments of the present invention provide a more dynamic, flexible approach that enables quicker ad-hoc connections between imaging repositories.

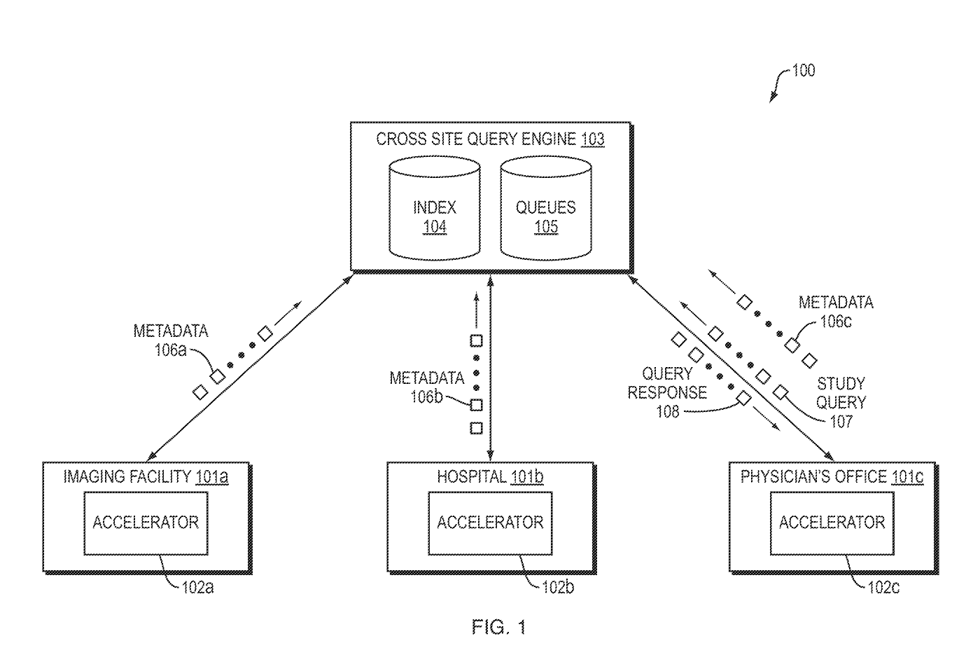

FIG. 1 is a simplified block diagram of a system 100 for performing cross site queries according to an embodiment of the present invention. The term “cross site query” is used herein to refer to imaging study queries across multiple repositories. Principal components of the system 100 include the cross site query engine 103 and the imaging repositories 101a-c. In the system 100, the cross site query engine 103 and the imaging repositories 101a-c are communicatively coupled via any means known in the art. In other words, the system 100, cross site query engine 103, and imaging repositories 101a-c may use any communication protocol known in the art.

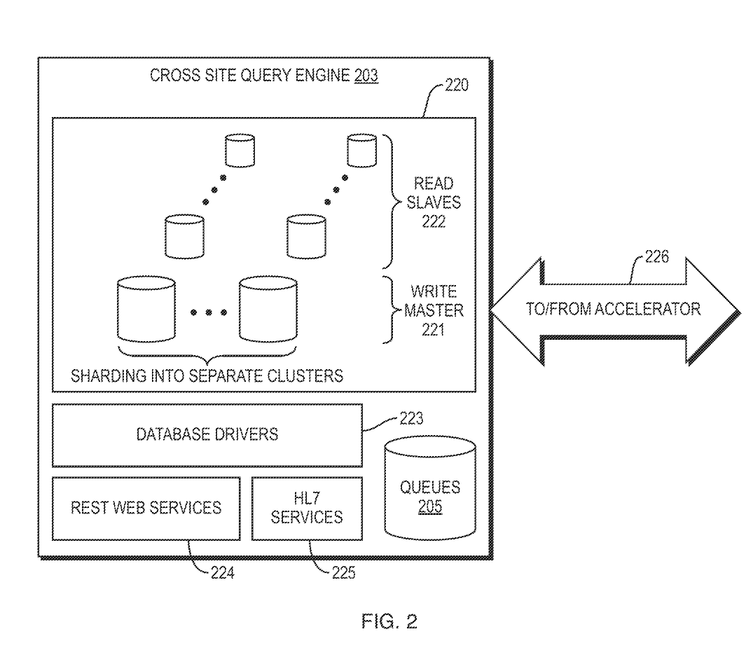

The cross site query engine 103 may be implemented as a cloud-based computing platform that facilitates embodiments of the invention described herein. The cross site query engine 103 includes the index 104 and the queue(s) 105. The index 104 is an index of existing imaging data, i.e., an organized data structure that contains data regarding existing imaging study data. For example, the index 104 may contain a list of all imaging studies, organized by patient (or otherwise, such as by facility, study, doctor, etc.) and may further include data regarding the type of imaging study, the date the imaging study was performed, the location at which the study was performed, and who performed the imaging study. It should be understood that the foregoing is a non-exhaustive list of data that may be included in the index 104, and any data regarding imaging studies may be part of the index 104. The queue(s) 105 contain queued imaging study queries that are received at the imaging study query engine 103. The index 104 and queue(s) 105 may be maintained via any storage method known in the art. For example, the index 104 and the queue 105 may be stored on one or more tangible, non-transitory, storage devices. Further details regarding the cross site query engine 103 are described hereinbelow in relation to FIG. 2.

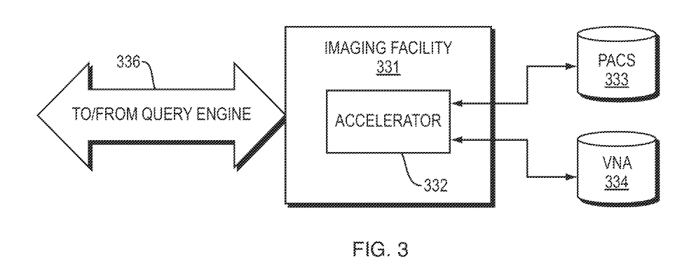

In the embodiment of FIG. 1, the cross site query engine 103 is communicatively coupled to the imaging repositories 101a-c. The imaging repositories 101a-c are each associated with a source of imaging study data, e.g., an imaging facility, hospital, physician's office, etc. While not shown in FIG. 1, each imaging repository 101a-c includes and/or is communicatively coupled to an imaging study storage device that may include a database or otherwise serve as a medium used to store or organize stored data and enable data searching and/or retrieval. The repositories 101a-c each store their respective imaging study data, e.g., x-ray data, on their respective storage device(s). The repositories 101a-c each include a respective accelerator device 102a-c. The accelerator devices 102a-c are communicatively coupled to each repositories' 102a-c imaging study storage device(s). Further, the accelerator devices 102a-c are each configured to acquire metadata 106 regarding each facilities' 101a-c imaging study data. The metadata 106 may include any data regarding the imaging study data, such as: time and date of creation, data type, author, location, etc. Further details regarding an example imaging study repository 101 according to embodiments of the present invention are described hereinbelow in relation to FIG. 3.

Described below is an example implementation of an embodiment of the present invention in the system 100. According to an example embodiment, each imaging facility 101a-c, via its respective accelerator device 102a-c, sends metadata 106a-c to the cross site query engine 103. This metadata 106a-c provides data regarding existing imaging studies that are stored at and/or by the respective imaging facilities 101a-c. In turn, the cross site query engine 103 creates an index 104 utilizing the metadata 106a-c. The index 104 provides the cross site query engine 103 with knowledge as to imaging studies that exist at the respective repositories 101a-c. The created index 104 facilitates fast responses to imaging study queries.

For example, in a scenario where a patient is visiting the physician's office 101c to follow-up regarding a broken thumb, the physician needs access to x-ray data; however, the patient's hand x-ray was taken at the hospital 101b. By utilizing the system 100, the physician can access such data. To do so, the physician's office 101c sends a study query 107 to the cross site query engine 103. The query engine 103 then checks the index 104 to determine if data relevant to the query, i.e., the hand x-ray, is available at any of the repositories 101a-c. Upon checking the index 104, the cross site query engine 103 determines that relevant data exists at the hospital 101b and sends a query response 108 to the physician's office 101c indicating that relevant data exists. Further, the cross site query engine 103 can request the x-ray data from the hospital 101b and provide the relevant data to the physician's office 101c.

Further, while the aforementioned embodiment utilized the index 104 that included metadata regarding the hand x-ray, embodiments of the present invention are not so limited. In an example embodiment, in response to checking the index 104 and determining that relevant imaging study data does not exist, the cross site query engine 103 may send a demand to the accelerator devices 102a-c to provide up-to-date metadata, thus, ensuring that the most accurate response is provided. Further, in yet another embodiment, the demands may be tailored so as to only be sent to appropriate facilities. For example, demands may be tailored based upon geographic location, and/or types of imaging study data, amongst other example filtering parameters. The data may also be “pushed” to subscribers, such as the hospital 101b and physician's office 101c with respect to the imaging facility 101a or the cross site query engine 103 to the imaging sources 101a, 101b, 101c. The engine 103 may then, in turn, push the collected data to its subscribers, but not to the imaging source that provided the data in some embodiments.

Further still, while the cross site query engine 103 is illustrated with an index 104, no such index is needed in an alternative embodiment of the present invention. In such an embodiment, in response to a study query 107, the cross site query engine 103 sends queries to the other repositories, i.e., the repositories 101a and 101b, requesting data relevant to the query 107. In response, the repositories 101a and 101b send data to the cross site query engine 103 indicating whether relevant imaging study data exists. The cross site query engine 103 then formulates a query response 108, which is, in turn, sent to the querying repository 101c. Thus, such an embodiment does not require an index but, may require a longer amount of time to respond to search queries.

FIG. 2 is a simplified block diagram of a cross site query engine 203 that may be utilized in embodiments of the present invention. The cross site query engine 203 may be implemented in hardware, software, or some combination thereof. The cross site query engine 203 includes the database 220. The database 220 may be any database known in the art, for example, a NoSQL database. In the cross site query engine 203, the database 220 shards data into separate clusters. This is implemented by the write masters 221 and the read slaves 222. The database 220 may store any data utilized by embodiments described herein. For example, imaging study data, data indices, etc. The cross site query engine 203 further includes the database drivers 223, which handle data virtualization and facilitate the storage of data. For example, the drivers 223 may facilitate storing data received from accelerator devices via the communications channel 226 in the database 220. The drivers 223 may further facilitate obtaining data from data sources other than the accelerator devices and may obtain data from any source communicatively coupled to the cross site query engine 203.

The cross site query engine 203 further includes the Representational State Transfer (REST) web services 224. The REST web services 224 may control and guide the accelerators described herein. For example, the REST web services 224 may facilitate sending demands for imaging study metadata to the accelerators, and further, may control accelerators to send metadata on a periodic or on-demand basis. Further still, the REST web services 224 may facilitate obtaining relevant imaging study data itself, e.g., a MRI. Further, the REST web services 224 may implement an application program interface (API) that allows users to facilitate communication with the cross site query engine 203. Further still, in an embodiment, the REST web services 224 may interface with other existing software resources or data sources, such as an electronic master patient index.

The cross site query engine 203 further includes the Health Level-7 (HL7) services 225. The HL7 services 225 implement communication between the various accelerator devices and the cross site query engine 203. Accelerator devices are capable of relaying HL7 order and report data from imaging facilities to the cross site query engine 203. This HL7 order and report data can be included in the index, described herein, as complimentary metadata to the DICOM query metadata. The cross site query engine 203 further includes the queue(s) 205. The queue(s) 205 allow a centralized queue of imaging study queries to be created. These imaging study queries may be received from the various accelerator devices as described herein. The queries stored in the queue 205 may be received via the communication channel 226, via any communication means known in the art.

FIG. 3 is a simplified block diagram of an imaging facility 331 that may be utilized in an embodiment of the present invention. The imaging facility 331 includes the accelerator device 332. The accelerator device 332 may be implemented in hardware, software, or some combination thereof. The accelerator device 332 performs a variety of functions, chief among them being data communications between the cross site query engine and the imaging facility 331. These communications may be performed via the communication channel 336, which may implement communication via any means known in the art. The accelerator device 332 is communicatively coupled to the PACS system 333 and the VNA system 334. The PACS system 333 and the VNA 334 represent possible storage devices/systems that contain imaging study data. While the PACS system 333 and the VNA 334 are illustrated as directly coupled to the accelerator 332, embodiments of the present invention are not so limited. The imaging study storage devices, e.g., PACS 333 and VNA 334 need only be in communication with the accelerator 332, but may be located remotely in respect to the accelerator 332. The PACS system 333 and the VNA 334 may be configured to operate in accordance with principles known in the art.

The accelerator device 332 may be further configured to operate in accordance with policy and state data specific to the imaging facility 331. Further, the accelerator 332 may be configured to contain various modules to facilitate the accelerator's 332 various functions. For example, the accelerator 332 may include a DICOM query service class user (SCU) and a REST client. The DICOM SCU may operate in accordance with known principles. Further, the REST client may operate to send data to the cross site query engine as described herein. The accelerator 332 may further index the data stored on the PACS 333 and the VNA 334. This data may be indexed according to any variety of parameters, including query frequency, activity time frame, indexing range, etc. Further still, the accelerator 332 can be configured to rescan data routinely to look for updates and may employ an HL7 update feed to indicate changed records.

As described herein, the accelerator device 332 is configured to send metadata associated with the imaging studies that are stored on the PACS system 333 and the VNA 334 to the cross site query engine. Further, the accelerator 332 may send this metadata in response to a demand or on some periodic basis. Moreover, the accelerator 332 may include a retrieve component that is configured to take directives from the cross site query engine to obtain and send imaging study data to the cross site query engine. According to one such embodiment, these directives come from a REST web service.

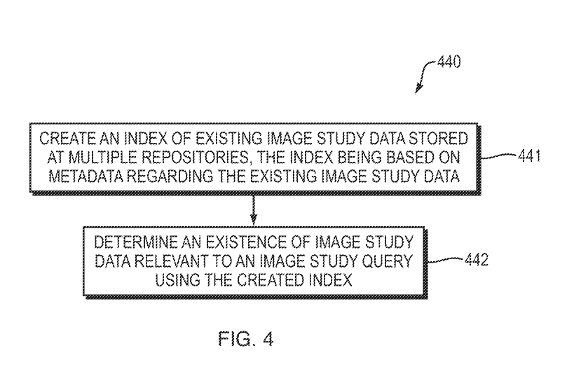

FIG. 4 is a flow diagram of a method 440 for querying imaging studies across multiple facilities and repositories. The method 440 begins by creating an index of existing imaging study data which is stored at multiple repositories (441). In such an embodiment, the index is based on metadata regarding the existing imaging study data. Further, the method 440 may determine an existence of imaging study data relevant to an imaging study query using the created index (442).

An embodiment of the method 440 may further include receiving the metadata from one or more accelerator devices located at the multiple repositories. In one or more embodiments of the method 440, the metadata may be received on a periodic basis and/or in response to a demand. Yet another embodiment of the method 440 further includes providing imaging study data in response to the query if it is determined that relevant imaging study data exists. An alternative embodiment provides an indication that imaging study data relevant to the query does not exist.

Embodiments of the method 440 may include receiving the metadata from any source that has such data. According to one example embodiment of the method 440, the metadata is received from at least one of an imaging facility, hospital, and physician's office. Further still, in embodiments of the method 440, the multiple repositories are each DICOM archives, such as a PACS or VNA.

Embodiments of the method 440 may further include tracking a patient using the index. In such an embodiment, the index is utilized to identify the various locales where a patient has had imaging studies.

A further embodiment of the method 440 seeks to avoid duplicative imaging studies. In such an embodiment, a medical provider is notified of an existing imaging study in response to an imaging study order using the created index. In such an embodiment, imaging study orders may be monitored and automatically checked against the created index to determine if a duplicative imaging study already exists. If it is determined that such a duplicative study exists, the physician may be automatically notified. In an alternative embodiment, an imaging facility, e.g., a doctor's office, may proactively request that it be determined if a particular imaging study exists. A determination can, in turn, be made using the index, and the imaging facility can be notified of any such relevant study.

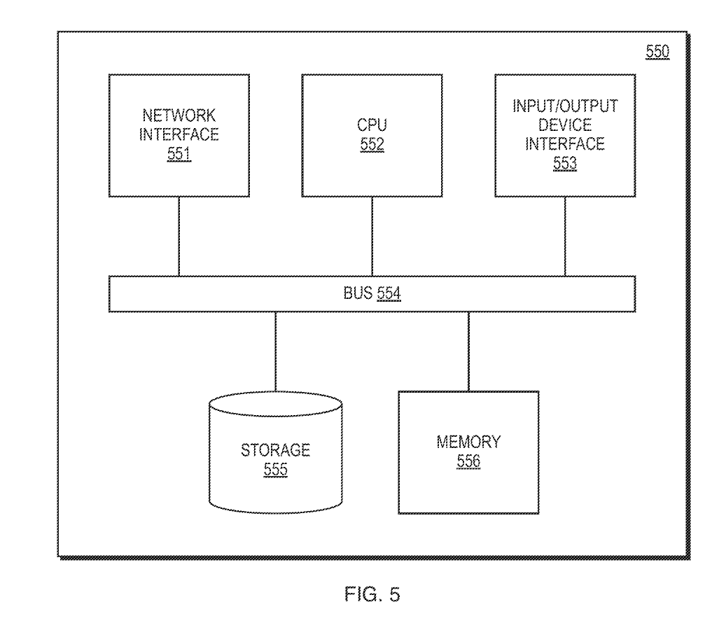

FIG. 5 is a simplified block diagram of a computer based system 550, which may be used to query imaging studies across multiple facilities and repositories. The system 550 comprises a bus 554. The bus 554 serves as an interconnect between the various components of the system 550. Connected to the bus 554 is an input/output device interface 553 for connecting various input and output devices, such as a keyboard, mouse, display, speakers, etc. to the system 550. A central processing unit (CPU) 552 is connected to the bus 554 and provides for execution of computer instructions. Memory 556 provides volatile storage for data used for carrying out computer instructions. Storage 555 provides nonvolatile storage for software instructions such as an operating system (not shown). The system 550 also comprises a network interface 551 for connecting to for any variety of networks known in the art, including wide area networks (WANs) and local area networks (LANs).

It should be understood that the example embodiments described herein may be implemented in many different ways. In some instances, the various methods and machines described herein may each be implemented by a physical, virtual, or hybrid general-purpose computer, such as the computer system 550. The computer system 550 may be transformed into the machines that execute the methods described herein, for example, by loading software instructions into either the memory 556 or the non-volatile storage 555 for execution by the CPU 552.

The system 550 and its various components may be configured to carry out any embodiments of the invention described herein. For example, according to an embodiment of the invention, the system 550 creates an index of existing imaging study data stored at multiple repositories, where the index is based on metadata regarding the existing imaging study data. Further, the system 550 may be configured to determine an existence of imaging study data relevant to an imaging study query using the created index. The system 550 may obtain the metadata via the network interface 551, the input/output interface 553, and/or the storage device 555 or some combination thereof. Further, the generated index may be stored in the storage 555 and/or memory 556.

According to another embodiment, the system 550 may comprise various modules implemented in hardware, software, or some combination thereof that are configured to implement the various embodiments of the invention described herein.

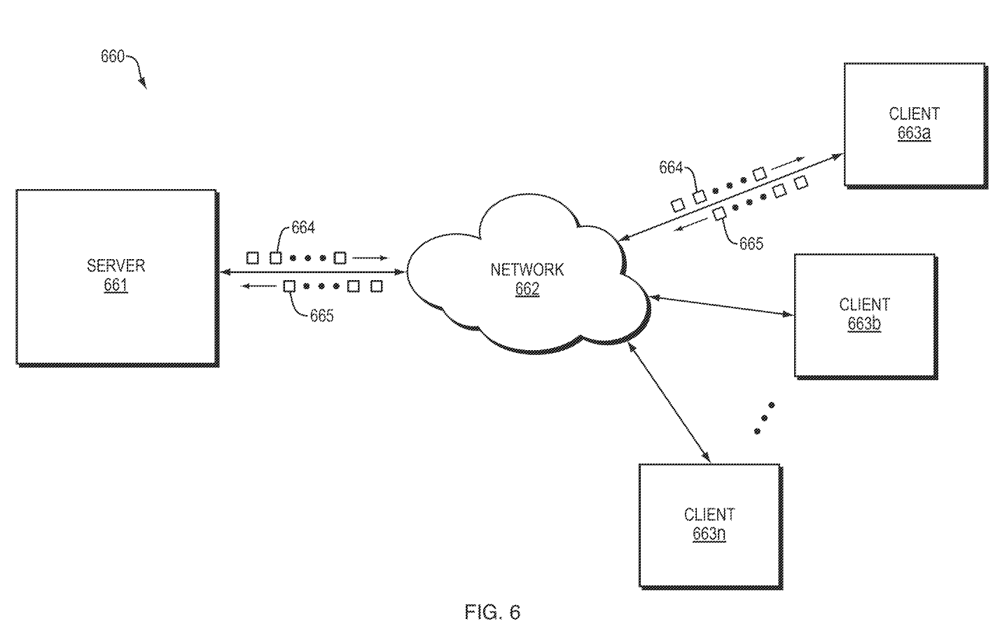

FIG. 6 illustrates a computer network environment 660 in which the present invention may be implemented. In the computer network environment 660, the server 661 is linked through a communications network 662 to the clients 663a-n. The environment 660 may be used to allow the clients 663a-n alone or in combination with the server 661 to execute the various methods described hereinabove. In an example embodiment, the client 663a sends an imaging study query shown by the data packets 665 via the network 662 to the server 661. In response, the server 661 will use an index of imaging study data to determine whether data relevant to the query exists. In response, an indication of whether relevant data exists shown by the packets 664 is sent to the client 663a.

Embodiments of the present invention may be implemented utilizing existing software platforms and infrastructure. One such platform is the Nuance PowerShare platform which is a software as a service platform that enables imaging facilities, physicians, and patients to establish accounts in a quasi-social network environment and collaborate with one another to exchange medical imaging data. The Nuance PowerShare platform may be configured to implement the various embodiments described herein. Thus, enabling users to discover whether relevant data at another facility exists. This can be extremely important in situations where new imaging procedures are ordered by physicians or when a radiologist reads a patient's new exam and needs to know if prior exams exist elsewhere. In such embodiments, the PowerShare platform may provide cross site query capability that utilizes accelerator devices located at the various imaging repositories. This functionality solves the problem of querying remote DICOM archive nodes at imaging facilities to discover what imaging exams are available at those sites and retrieving those imaging studies to the cloud and to other imaging facilities as needed.

Embodiments of the present invention may be implemented such that a cross site query engine centrally queues DICOM query and retrieve requests within the PowerShare cloud for any number of remotely registered DICOM archives. In such an embodiment, the requests may be made from a PowerShare web application or from other applications to an API. Respective accelerators installed on the respective LANs within the remote DICOM archives may be configured to retrieve the requests intended for their respective local archives and perform the corresponding DICOM query or retrieve operation. The results of queries, in turn, can be returned from the accelerators to the central cloud, aggregated, and returned to the requesting application. If a study retrieve was requested, the accelerator obtains the images from the archive node and forwards them to the PowerShare cloud.

Another embodiment of the present invention proactively collects metadata about studies stored at the remote DICOM archives and stores that metadata in a database in the cloud. Requests for data can then be responded to much more quickly. Additionally, embodiments may employ advanced access control and authorization logic to ensure that users can only access data that they have permission to access. Centralized Health Insurance Portability and Accountability Act (HIPAA) audit trails can maintain a full record of all performed transactions.

Further, embodiments of the present invention may provide an API layer that allows authorized third parties to leverage the network, and thus, the federated imaging study data, once it has been established.

Embodiments of the present invention can be utilized by any organization that is interested in avoiding repeat imaging examinations. Current estimates of the cost of unnecessary imaging exams are in the billions of dollars. Thus, if even a fraction of these can be avoided by providing better access to existing imaging studies at other locations, the value to the industry could be in the hundreds of millions of dollars. There is also significant commercial potential based on clinical value to radiologists and other specialists who need efficient access to prior exams from other sites.

As described hereinabove, embodiments of the present invention may utilize accelerator devices each in communication with cloud computing services that provide cross site query functionality. In an embodiment, accelerators may be implemented as light-weight software components that operate locally at the various imaging facilities. In one such example embodiment, the accelerators may be configured to perform periodic polling of the cloud services in an outbound connection from the imaging facility to the cloud services. This may be particularly advantageous because it can eliminate the need for firewalls to allow traffic inbound to the accelerator devices. According to such an embodiment, once an accelerator is installed, the accelerator provisions itself with the cloud services and gets registered and associated with its respective imaging facility and the facilities image repositories. In this way, the accelerator is immediately able to participate in the various global cross site query methods described herein.

It should be understood that the example embodiments described herein may be implemented in many different ways. In some instances, the various methods and machines described herein may each be implemented by a physical, virtual, or hybrid general purpose computer, or a computer network environment.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should also be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method of querying imaging studies across multiple facilities and repositories, the method comprising:
creating an index of existing imaging study data stored at multiple repositories, the index being based on metadata regarding the existing imaging study data; and
determining an existence of imaging study data relevant to an imaging study query using the created index.

2. The method of claim 1 further comprising:
receiving the metadata from one or more accelerator devices located at the multiple repositories.

3. The method of claim 2 further comprising:
receiving the metadata from the one or more accelerator devices on a periodic basis or in response to a demand.

4. The method of claim 1 further comprising:
centrally queueing a plurality of imaging study queries.

5. The method of claim 1 further comprising:
providing the imaging study data in response to the query if it is determined that relevant data exists or, otherwise, providing an indication that imaging study data relevant to the query does not exist.

6. The method of claim 1 wherein the metadata is received from at least one of:
an imaging facility;
a hospital; and
a physician's office.

7. The method of claim 1 wherein the multiple repositories are each a digital imaging and communications in medicine (DICOM) archive.

8. The method of claim 1 further comprising:
tracking a patient using the index.

9. The method of claim 1 further comprising:
in response to an imaging study order, notifying a medical provider of an existing imaging study using the created index.

10. A computer system for querying imaging studies across multiple facilities and repositories, the computer system comprising:
a processor; and
a memory with computer code instructions stored thereon, the processor and the memory, with the computer code instructions being configured to cause the system to:
create an index of existing imaging study data stored at multiple repositories, the index being based on metadata regarding the existing imaging study data; and
determine an existence of imaging study data relevant to an imaging study query using the created index.

11. The computer system of claim 10 wherein the processor and the memory, with the computer code instructions, are further configured to cause the system to:
receive the metadata from one or more accelerator devices located at the multiple repositories.

12. The computer system of claim 11 wherein the processor and the memory, with the computer code instructions, are further configured to cause the system to:
receive the metadata from the one or more accelerator devices on a periodic basis or in response to a demand.

13. The computer system of claim 10 wherein the processor and the memory, with the computer code instructions, are further configured to cause the system to:
centrally queue a plurality of imaging study queries.

14. The computer system of claim 10 wherein the processor and the memory, with the computer code instructions, are further configured to cause the system to:
provide the imaging study data in response to the query if it is determined that relevant data exists or, otherwise, provide an indication that imaging study data relevant to the query does not exist.

15. The computer system of claim 10 wherein the metadata is received from at least one of:
an imaging facility;
a hospital; and
a physician's office.

16. The computer system of claim 10 wherein the multiple repositories are each a digital imaging and communications in medicine (DICOM) archive.

17. The computer system of claim 10 wherein the processor and the memory, with the computer code instructions, are further configured to cause the system to:
track a patient using the index.

18. The computer system of claim 10 wherein the processor and the memory, with the computer code instructions, are further configured to cause the system to:
in response to an imaging study order, notify a medical provider of an existing imaging study using the created index.

19. A computer program product for querying imaging studies across multiple facilities and repositories, the computer program product comprising:
one or more computer-readable tangible storage devices and program instructions stored on at least one of the one or more storage devices, the program instructions, when loaded and executed by a processor, cause an apparatus associated with the processor to:
create an index of existing imaging study data stored at multiple repositories, the index being based on metadata regarding the existing imaging study data; and
determine an existence of imaging study data relevant to an imaging study query using the created index.

20. The computer program product of claim 19 wherein the metadata is received from one or more accelerator devices.
